(19) United States
(12) Patent Application Publication
(10) Pub. No.: US 2024/0430127 A1
(43) Pub. Date: Dec. 26, 2024

(54) METHOD, COMPUTER PROGRAM, AND DEVICE FOR PROCESSING SIGNALS

(71) Applicant: Volkswagen Aktiengesellschaft, Wolfsburg (DE)

(72) Inventors: Andreas Udo Sass, Hannover (DE); Christopher Vox, Braunschweig (DE); Jan Piewek, Magdeburg (DE)

(21) Appl. No.: 18/294,000

(22) PCT Filed: Jul. 28, 2022
(86) PCT No.: PCT/EP2022/071193

§ 371 Date: Feb. 12, 2024

(30) Foreign Application Priority Data
Aug. 6, 2021 (DE) 102021208610.1

(51) Int. Cl. H04L 12/40; G06F 18/2321; H04L 43/04

(52) U.S. Cl. CPC H04L 12/40032; G06F 18/2321; H04L 43/04; H04L 2012/40273

(57) ABSTRACT

Technologies and techniques for processing signals, wherein an optional preprocessing of the signals is carried out, and during the preprocessing, the signals are first sequenced into portions. A statistic characteristic is then determined for each of the portions. A characteristics space of the determined statistic characteristics can then optionally be transformed into a space of a lower dimension. The signals are then clustered using a cluster algorithm, wherein a number of clusters is adapted to an available bandwidth. Representatives are determined for the clusters resulting from the clustering. The signals specified as representatives may be provided for a transmission.

### RELATED APPLICATIONS

The present application claims priority to International Patent Application No. PCT/EP2022/071193 to Sass et al., filed Jul. 28, 2022, titled “Method, Computer Program, and Device for Processing Signals,” which claims priority to German Pat. App. No. DE 10 2021 208 510.1, filed Aug. 6, 2021, to Sass et al., the contents of each being incorporated by reference in their entirety herein.

### TECHNICAL FIELD

The present disclosure relates to a method, to a computer program including instructions, and to a device for processing signals in a process of continuous data provision. The present disclosure furthermore relates to means of transportation in which associated methods or devices are used.

### BACKGROUND

In general, a plurality of sensors are installed in today's means of transportation, for example motor vehicles, which provide signals with respect to a series of components of the means of transportation. In addition to the sensor signals, modelled variables are also exchanged within the vehicle, which were not measured, but calculated using an internal model. Other signals that occur are controlled variables, which specify a control to actuators installed in the vehicle. These signals can be utilized, amongst others, to make an aging prediction in a data-driven manner. Likewise, such signals can be transmitted as telematics data for use to an external server. The transmission is generally carried out by means of mobile radio communication.

During the data transmission, it must be taken into consideration that motor vehicles drive through cities and localities having different variants of the available mobile radio standards, such as WLAN, 2G, 3G, 4G or, in the future, also 5G. Differing utilization levels of individual radio cells over time also result in a bandwidth that varies temporally and spatially. A high bandwidth must be available for transmitting vehicle signals, usually data of CAN messages, since CAN signals usually have a temporal resolution of 10 ms. So as to be able to transmit the data also in localities that have a poorer mobile radio infrastructure, only selected or reduced volumes of data may possibly be transmitted. As a result, algorithms are used on a regular basis for loss-free or lossy data compression.

Against this background, DE 10 2016 100 302 A1 describes a method for providing telematics data of vehicles. In the method, a parameter definition of a processed parameter to be computed by an electronic control unit is received from a remote server. According to the parameter definition, the processed parameter is generated based on a raw parameter generated by the electronic control unit. The processed parameter is then sent to a vehicle data buffer for upload to the remote server. Prior to being uploaded, the data are processed by an algorithm, and a lossy data compression is carried out.

EP 2 573 727 A1 describes a telematics on-board unit for a vehicle. The telematics on-board unit comprises means for collecting vehicle usage data, means for transmitting collected vehicle usage data, or analyzed vehicle usage data derived therefrom, to a telematics service platform, and means for identifying a driver using the vehicle and for providing a driver identification. Before data are transmitted to the telematics service platform, a data compression is carried out.

However, mere compression of the data often cannot achieve the required reduction of the data volume. In addition, it would be desirable to be able to adapt the degree of the compression to the available bandwidth.

Against this background, DE 10 2019 219 922 A1 describes a method for transmitting a plurality of signal. In the method, the plurality of signals are picked up in a time window. Signals that have a similar waveform in the time window are grouped into a respective group. A signal of the respective group is determined as a representative of the group. Thereafter, transmission data are transmitted, including, for each group, the representative of the respective group, as well as a respective piece of transformation information for each signal contained in the respective group.

The article C. Guyeux et al.: “Introducing and Comparing Recent Clustering Methods for Massive Data Management in the Internet of Things”, Journal of Sensor and Actuator Networks, Vol. 8 (2019), surveys and compares popular and advanced clustering methods and provides a detailed analysis of their performance as a function of scale, type of collected data or the heterogeneity thereof, and noise level.

### SUMMARY

Aspects of the present disclosure are directed to providing solutions for processing signals in a process of continuous data provision which allow a degree of a data compression to be easily adapted.

Some aspects of the present disclosure are provided in the subject matters of the independent claims, found below. Other aspects are disclosed in the subject matter of the respectively associated dependent claims, the description and the figures.

In some examples, a method is disclosed for processing signals in a process of continuous data provision, comprising the following steps:
sequencing the signals into segments;
determining at least one statistical feature for each of the segments;
clustering the signals based on the determined statistical features by means of a clustering algorithm;
determining representatives for the clusters; and
providing the representatives for a transmission;
   wherein a number of the clusters is automatically adapted to a changing available bandwidth by forming a large number of clusters in the case of a high bandwidth, and thus transmitting a large number of representatives, forming a medium number of clusters in the case of a medium bandwidth, and thus transmitting a smaller number of representatives, and forming few clusters are formed in the case of a low bandwidth, and thus transmitting few representatives.

In some examples, a computer program is disclosed, including instructions that, when being executed by a computer, prompt the computer to carry out the following steps for processing signals in a process of continuous data provision:
sequencing the signals into segments;
determining at least one statistical feature for each of the segments;
clustering the signals based on the determined statistical features by means of a clustering algorithm;
determining representatives for the clusters; and
providing the representatives for a transmission;
wherein a number of the clusters is automatically adapted to a changing available bandwidth by forming a large number of clusters in the case of a high bandwidth, and thus transmitting a large number of representatives, forming a medium number of clusters in the case of a medium bandwidth, and thus transmitting a smaller number of representatives, and forming few clusters in the case of a low bandwidth, and thus transmitting few representatives.

The term ‘computer’ as used herein shall be understood broadly. In particular, the term also encompasses microcontrollers, embedded systems, and other processor-based data processing devices.

The computer program can, for example, be provided for electronic retrieval or be stored on a computer-readable memory medium.

In some examples, a device is disclosed for processing signals, wherein the device comprises the following modules:
a sequencing module for sequencing the signals into segments;
an analysis module for determining at least one statistical feature for each of the segments;
a clustering module for clustering the signals based on the determined statistical features by means of a clustering algorithm;
a selection module for determining representatives for the clusters; and
an output module for providing the representatives for a transmission;
wherein the clustering module is configured to automatically adapt a number of the clusters to a changing available bandwidth by forming a large number of clusters in the case of a high bandwidth, and thus transmitting a large number of representatives, forming a medium number of clusters in the case of a medium bandwidth, and thus transmitting a smaller number of representatives, and forming few clusters in the case of a low bandwidth, and thus transmitting few representatives.

The technologies and techniques disclosed herein may be particularly advantageously used in a (semi-)autonomously or manually controlled means of transportation. The means of transportation can, in particular, be a motor vehicle, but may also be a ship, an aircraft, for example a Volocopter, a construction machine, and the like. A use in mobile production machines is also possible. The data to be transmitted can be utilized for telematics services, for example. In the future, these data can also be utilized for predictive services, such as predictive maintenance. For this purpose, it is useful for data of the entire vehicle life to be available. In the process, it is more important to have data over the entire vehicle life for an evaluation than that the data have a particularly high resolution, both temporally and with respect to discretization, but are incomplete.

### DESCRIPTION OF THE DRAWINGS

Further features of the present invention can be derived from the following description and the accompanying claims, in conjunction with the figures.

FIG. 1 schematically shows a method for processing signals, according to some aspects of the present disclosure;

FIG. 2 shows a first embodiment of a device for processing signals, according to some aspects of the present disclosure;

FIG. 3 shows a second embodiment of a device for processing signals, according to some aspects of the present disclosure;

FIG. 4 schematically represents a means of transportation in which a solution according to the invention is implemented, according to some aspects of the present disclosure;

FIG. 5 schematically shows a series of signals to be subjected to a preprocessing step, according to some aspects of the present disclosure;

FIG. 6 schematically shows the signals from FIG. 5 after completion of the preprocessing step, according to some aspects of the present disclosure

FIG. 7 schematically shows a division of the preprocessed signals into segments, according to some aspects of the present disclosure;

FIG. 8 illustrates an extraction of feature vectors from the segments, according to some aspects of the present disclosure;

FIG. 9 illustrates a transformation of the feature vectors into a statistical feature space, according to some aspects of the present disclosure;

FIG. 10 illustrates a transformation of the feature space of the statistical features into a one-dimensional representation, according to some aspects of the present disclosure;

FIG. 11 illustrates clusters generated based on the one-dimensional representation of the statistical features, according to some aspects of the present disclosure;

FIG. 12 illustrates one example of a clustering step using a large number of clusters, a medium number of clusters, and few clusters, according to some aspects of the present disclosure; and

FIG. 13 shows an associated silhouette index for different numbers of clusters resulting from the clustering step, according to some aspects of the present disclosure.

### DETAILED DESCRIPTION

To provide a better understanding of the principles of the present invention, embodiments of the invention will be described hereafter in greater detail based on the figures. It shall be understood that the invention is not limited to these embodiments, and that the described features can also be combined or modified, without departing from the scope of protection of the invention, as it is defined in the accompanying claims.

In the examples provided herein, the vehicle data to be transmitted may be reduced by setting the quality of an evolutionary signal clustering method in a bandwidth-adaptive manner so that a lossy data compression is carried out, as a function of the available bandwidth. With the aid of signal clustering, vehicle signals are combined in clusters or groups. For data transmission, only a representative of a cluster may be used, whereby a significant data reduction can be achieved in a highly correlated signal space. The clustering algorithm is set so that the number of resulting clusters is automatically adapted to the available bandwidth. At a high bandwidth, a large number of clusters may thus arise, accordingly resulting in a large number of representatives. In this case, a large number of data are sent. If the available bandwidth is low, the algorithm is set so that only few clusters arise. Thus, only few representatives result, and only few data are transmitted.

If no network is available for the data transmission, the data can be stored in an available data buffer. This data buffer is designed so as to be able to bridge at least short stays in a region without network coverage. The data buffer is preferably dimensioned, in terms of the size thereof, so that no data are lost during a time period of two hours, for example, in which no connection to the radio network exists.

When the data buffer has been filled and transmission is still not possible, the signals can subsequently be clustered again so that fewer clusters, and thus fewer data, arise in the buffer. In this case, a more extensive loss of information is tolerated.

In some examples, the signals are sequenced into segments, and at least one statistical feature is determined for each of the segments. The signals may then be clustered, based on the determined statistical features.

In many cases, the data base may include measurements in a very high resolution, for example, data from the CAN bus. However, the clustering of the time series of these signals does not necessarily produce any usable results. There are several reasons for this. For one, the signals have varying resolution levels, which is why a direct comparison is only possible with very high time expenditure and computing complexity, even if very similar signals are involved, such as, the front right wheel speed and the front left wheel speed. Additionally, the signals are so highly dynamic that they are not assigned to a shared cluster by the algorithm in the high-resolution representation, even though, for a human, they very obviously correspond to the same clusters. Finally, clustering of the original time series is so memory-intensive that this is only possible in sequences, for example in segments having a duration of ten minutes each.

Experiments using such segments, however, yielded poor results. According to some aspects of the present disclosure, the data base can likewise be broken down into small sequences. These sequences can, for example, have a duration of ten minutes or also of hours. Statistical features are now computed for these sequences, that is, statistical, artificial characteristic values are aggregated from the time intervals. These features serve as input data for a clustering algorithm. The result is clustered signals. These clusters can be used as a starting basis for further processing steps. Preferably, a refined data base is used as the data base, in which the input data are equidistant and have the same length. Since only simple mathematical operations are required, the clustering algorithm can be implemented on the side of the signal detection in the means of transportation. This allows data-efficient storage.

In some examples, hyperparameters of the clustering algorithm may be set for adapting the number of the clusters to the available bandwidth. Hyperparameters influence the result of the clustering step, that is, different quality levels and cluster numbers result from the setting of the hyperparameters. Which hyperparameters are available, and what effects the hyperparameters have on the number of clusters, depend on the selected clustering algorithm and the respective signals to be clustered. The settings of the hyperparameters for different available bandwidths can, for example, be experimentally determined in advance.

In some examples, a feature space of the determined statistical features may be transformed, prior to clustering, into a space having a lower dimension. Preferably, a transfer into a one-dimensional representation takes place in the process. The transformation into a space having a lower dimension result in high-quality data compression for signal description. The resulting reduced data basis is particularly advantageous for the correct identification of identical signals in the existing signal space since it facilitates machine-processing of the data, and supports an error-free signal assignment.

According to one aspect of the invention, principal component analysis may be applied to the determined statistical features for the transformation of the feature space, or at least one determined statistical feature is selected. The principal component analysis, which is also known as principal axes transformation, is ideally suited for structuring comprehensive data sets by approximating the existing statistical variable using a smaller number of principal components that are as meaningful as possible. As an alternative, the option exists to utilize only one determined statistical feature, or a reduced selection of statistical features, for example the mean value of certain time periods. This approach can also be employed to yield suitable results. It is possible to empirically determine which statistical features are best-suited for a specific application. The selection of the statistical features can preferably be adapted during operation.

Under some aspects of the present disclosure, the at least one statistical feature may be configured as a mean value, a maximum value, a minimum value, or a quantile. The quantile may be a quartile, that is, the quantiles Q_{0.25}, Q_{0.5}, and Q_{0.75}, also referred to as lower quartile, median quartile, and upper quartile. All of these statistical features are well-suited for a subsequent formation of clusters. Of course, it is also possible for a selection or subset of statistical features to be determined.

In some examples, a density-based clustering method, a partitional clustering method, or a hierarchical clustering method may be employed for clustering the signals. A Density-Based Spatial Clustering of Applications with Noise (DBSCAN) algorithm, for example, can be employed as a density-based clustering method. The use of a K-means algorithm may also be an advantageous choice for a partitional clustering method. Examples of suitable hierarchical clustering methods are agglomerative clustering or a mean-shift algorithm. The use of hierarchical clustering methods have the advantage that no prior knowledge regarding the number of clusters is required. In addition, the form of the clusters is not limited. Preferably, silhouette coefficients are utilized to detect the clustering quality.

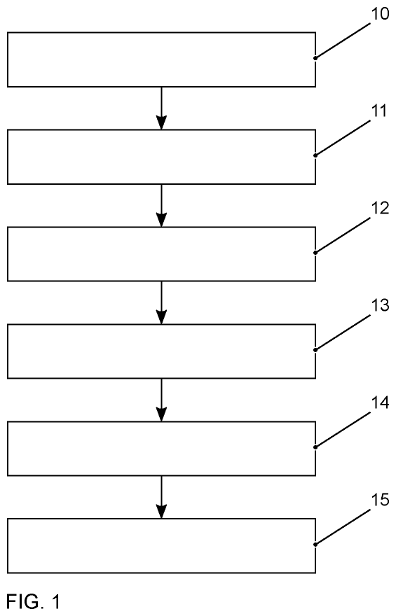

Turning to FIG. 1, the drawing schematically shows a method for processing signals in a process of continuous data provision, for example sensor signals, modelled variables or controlled variables. In this example, the signals are initially preprocessed. Within the scope of this preprocessing step, the signals may be initially sequenced 10 into segments. For each of the segments, at least one statistical feature is then determined 11, for example a mean value, a maximum value, a minimum value, or a quantile. Thereafter, a feature space of the determined statistical features can optionally be initially transformed 12 into a space having a lower dimension. For this purpose, for example, principal component analysis can be applied to the statistical features, or at least one determined statistical feature can be selected. The signals are now clustered 13 by means of a clustering algorithm based on the determined statistical features. For example, hyperparameters of the clustering algorithm can be set for adapting the number of clusters to the available bandwidth. The clustering algorithm can, for example, implement a density-based clustering method, a partitional clustering method, or a hierarchical clustering method. Thereafter, representatives are determined 14 for the clusters resulting from clustering 13. At least the signals determined as representatives are finally provided 15 for a transmission. During the clustering 13 of the signals, a number of the clusters is automatically adapted to a changing available bandwidth by forming a large number of clusters in the case of a high bandwidth, and thus transmitting a large number of representatives, forming a medium number of clusters in the case of a medium bandwidth, and thus transmitting a smaller number of representatives, and forming few clusters in the case of a low bandwidth, and thus transmitting few representatives.

FIG. 2 shows a simplified schematic representation of a first embodiment of a device 20 for processing signals in a process of continuous data provision, for example sensor signals, modelled variables or controlled variables. The device 20 has an input 21, via which signals Sᵢ of different sensors 41ᵢ can be received, of which two are illustrated by way of example. For preprocessing the signals Sᵢ, a sequencing module 22 and an analysis module 23 are provided. The sequencing module 22 is configured to sequence the signals Sᵢ into segments. The analysis model 23 determines at least one statistical feature, for example a mean value, a maximum value, a minimum value, or a quantile, for each of the segments. The analysis module 23 can optionally be configured to transform a feature space of the statistical features, after the features have been determined, into a space having a lower dimension, for example by applying principal component analysis to the statistical features or by selecting at least one determined statistical feature.

A clustering module 24 thereafter clusters the signals Sᵢ by means of a clustering algorithm based on the determined statistical features. For example, hyperparameters of the clustering algorithm can be set for adapting the number of clusters to the available bandwidth. The clustering algorithm can, for example, implement a density-based clustering method, a partitional clustering method, or a hierarchical clustering method. The clustering module 24 is moreover configured to determine representatives Rᵢ for the clusters resulting from the clustering. Finally, at least the signals Sᵢ determined as representatives Rᵢ are provided for a transmission via an output 27 of the device 20. The clustering module 24 is configured, during the clustering of the signals Sᵢ, to automatically adapt a number of the clusters to a changing available bandwidth by forming a large number of clusters in the case of a high bandwidth, and thus transmitting a large number of representatives Rᵢ, forming a medium number of clusters in the case of a medium bandwidth, and thus transmitting a smaller number of representatives Rᵢ, and forming few clusters in the case of a low bandwidth, and thus transmitting few representatives Rᵢ.

The sequencing module 22, the analysis module 23, and the clustering module 24 can be controlled by a control module 25. Via a user interface 27, settings of the sequencing module 22, of the analysis module 23, of the clustering module 24, or of the control module 25 can be changed, where necessary. The data arising in the device 20 can be saved, if needed, to a memory 26 of the device 20, for example for a later evaluation or for use by the components of the device 20. The sequencing module 22, the analysis module 23, the clustering module 24, as well as the control module 25 can be implemented as dedicated hardware, for example as integrated circuits. However, they can, of course, also be partially or completely combined or implemented as software running on a suitable processor, for example on a GPU or a CPU. The input 21 and the output 27 can be implemented as separate interfaces or as one combined bidirectional interface.

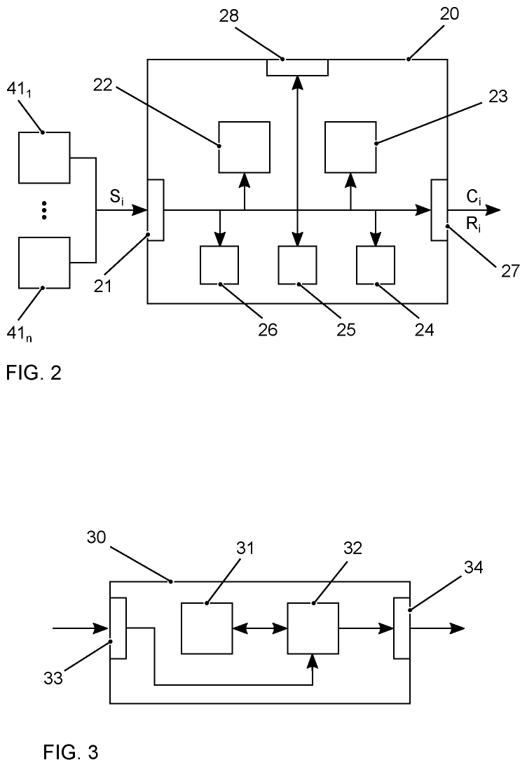

FIG. 3 shows a simplified schematic representation of a second embodiment of a device 30 for processing signals in a process of continuous data provision. The device 30 comprises a processor 32 and a memory 31. For example, the device 30 is a microcontroller or an embedded system. Instructions are saved in the memory 31, which prompt the device 30, when the instructions are being executed by the processor 32, to carry out the steps according to one of the described methods. The instructions saved in the memory 31 thus embody a program that can be executed by the processor 32 and implements the method according to the invention. The device 30 has an input 33 for receiving information, and in particular signals. Data generated by the processor 32 are provided via an output 34. Additionally, the data can be saved in the memory 31. The input 33 and the output 34 can be combined to a bidirectional interface.

The processor 32 can comprise one or more processor units, for example microprocessors, digital signal processors, or combinations thereof.

The memories 26, 31 of the described embodiments can include both volatile and non-volatile memory areas and encompass a wide variety of memory devices and memory media, for example hard disks, optical memory media, or semiconductor memories.

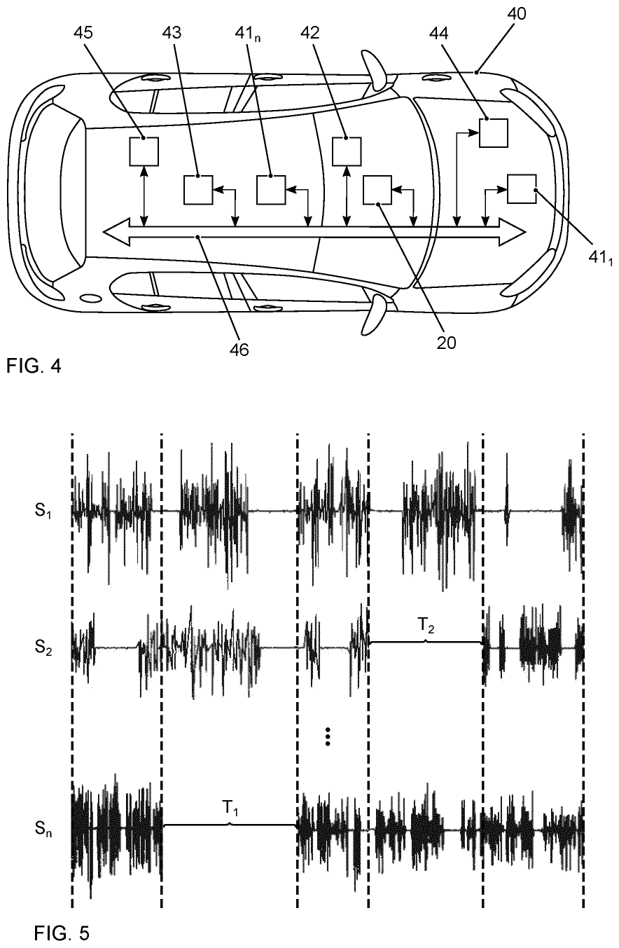

Further details of aspects of the present disclosure will be described hereafter based on FIG. 4 to FIG. 11. In these embodiments, signals of a means of transportation are considered. It should be understood by those skilled in the art that the examples are non-limiting, and that other suitable configurations are contemplated in the present disclosure. Some aspects of these disclosure may also be used in mobile production machines.

FIG. 4 schematically represents a means of transportation 40, illustrated as a motor vehicle in the example. The motor vehicle comprises a plurality of sensors 41ᵢ, some of which are shown by way of example and provide sensor signals with respect to a series of components of the motor vehicle. The motor vehicle furthermore comprises a device 20 for processing signals. Further components of the motor vehicle include a navigation system 42, a data transmission unit 43, as well as a series of assistance systems 44, one of which is shown by way of example. A connection to service providers for further processing the signals can be established by means of the data transmission unit 43. A memory 45 is also configured for storing data. The data exchange between the various components of the motor vehicle is carried out via a network 46, for example via a CAN bus.

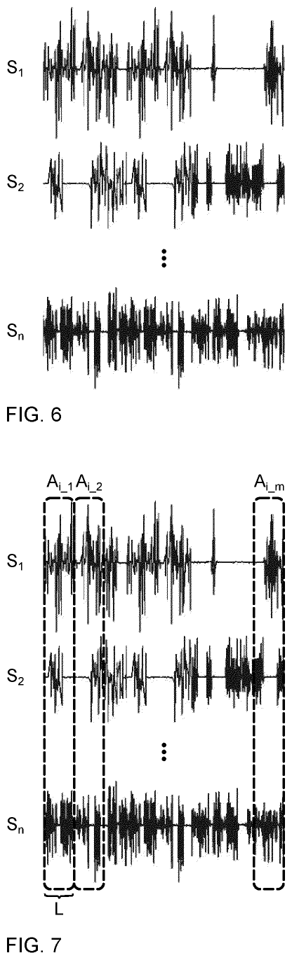

FIG. 5 schematically shows a series of signals Sᵢ to be subjected to a preprocessing step. In this example, there are n signals Sᵢ present, of which three signals S₁, S₂, Sₙ are shown. The signals can be sensor signals, modelled variables, or controlled variables, for example. The signals Sᵢ can be transmitted on the CAN bus of a motor vehicle. In part, gaps or time periods Tᵢ during which no usable data are present occur in the signals Sᵢ. These time periods Tᵢ are preferably removed from all signals Sᵢ within the scope of a preprocessing step, that is, the corresponding time periods Tᵢ are cut from the signals Sᵢ. The signals Sᵢ after the preprocessing step has been completed are shown in FIG. 6.

FIG. 7 schematically shows a division of the preprocessed signals Sᵢ into segments A_{i_n}. In the illustrated example, the signals Sᵢ are divided into m segments A_{i_n}, each having the same length L. Based on these segments A_{i_n}, a time series interpretation is carried out, in which a feature vector is extracted for each signal Sᵢ for each of the segments A_{i_n}.

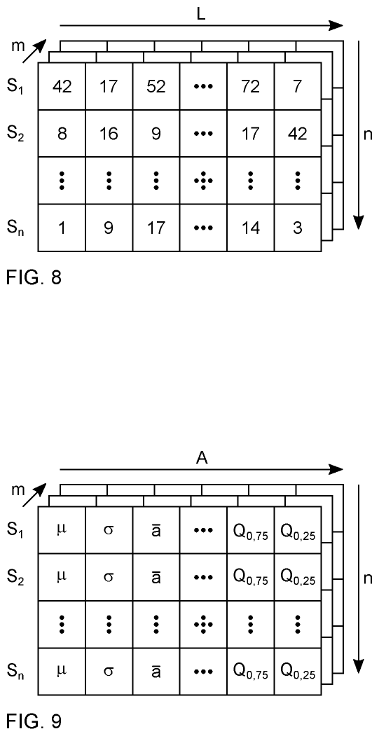

FIG. 8 illustrates the extraction of feature vectors from the segments A_{i_n}. After the extraction, m arrays having features are present. The dimensions of the m arrays are determined, on the one hand, by the number n of the signals and, on the other hand, by the length L of the individual signal segments A_{i_n}. Statistical features are now determined based on the individual feature vectors. The length L of the individual signal segments A_{i_n} can be empirically determined, for example. Evaluations have shown that an aggregation in the range of one hour achieves good result for a determination of an aging process that occurs over a usage time period of several hundred hours.

FIG. 9 illustrates a transformation of the feature vectors into a statistical feature space. After the statistical features have been determined, m arrays having statistical features are present. The dimensions of the m arrays are again determined, on the one hand, by the number n of the signals, but, on the other hand, now by the number A of the statistical features determined for each feature vector. Assuming that high-resolution time series in the vehicle are resolved with a frequency of 10 Hz, and if these time series are now each combined into one hour with the aid of a statistical feature, the volume of data is reduced from 1×60×60×10=36000 measured values to one value.

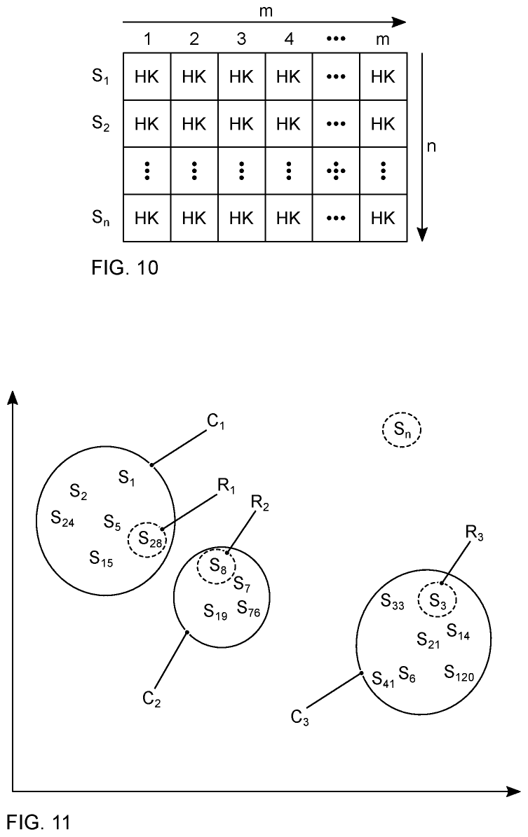

FIG. 10 illustrates a transformation of the feature space of the statistical features into a one-dimensional representation. For this purpose, the statistical features are subjected to principal component analysis. In this example, only a single principal component HK was maintained. After the principal component analysis, a single array having principal components HK is present. The dimensions of the array are again determined, on the one hand, by the number n of the signals, and, on the other hand, by the number m of the segments. This array serves as a basis for a clustering algorithm.

FIG. 11 illustrates clusters Cᵢ generated based on the one-dimensional representation of the statistical features. In the shown example, three clusters C₁, C₂, C₃ are apparent. Each cluster Cᵢ comprises a plurality of signals Sᵢ. In addition, a signal Sₙ exists, which is not assigned to any cluster Cᵢ. A signal Sᵢ can now be selected as a representative Rᵢ from each cluster Cᵢ. This can be, for example, the participant of the particular cluster Cᵢ that was found first, or the participant that, within the cluster Cᵢ, is closest to the center of the cluster Cᵢ. The representatives Rᵢ as well as the signal Sₙ, which is not assigned to any cluster Cᵢ, finally yield the resulting signal set, as is indicated by the dotted ellipses.

The first cluster C₁ can, for example, encompass the following signals Sᵢ:
S₁: speed of front left wheel
S₂: speed of front right wheel
S₂₄: speed of rear left wheel
S₁₅: speed of rear right wheel
S₅: speed of wheel
S₂₈: speed of the vehicle
   Thus, the signal S₂₈, that is, the speed of the vehicle, serves as representative R₁ of the first cluster C₁.

The second cluster C₂ can, for example, encompass the following signals Sᵢ:
S₇: computed gear
S₈: gear
S₇₆: target gear
S₁₉: gear 2
   The signal S₈, that is, the gear, serves as representative R₂ of the second cluster C₂.

The third cluster C₃ can, for example, encompass the following signals Sᵢ:
S₃: time 1
S₃₃: time 2
S₂₁: time 3
S₁₄: time 4
S₁₂₀: time 5
S₆: time 6
S₄₁: time 7
   The signal S₃, that is, a first time signal, serves as representative R₃ of the third cluster C₃.

Additional clusters can, for example, result from signals that indicate a position of the pedal and an engine power, or from signals that indicate an oil temperature and a coolant temperature.

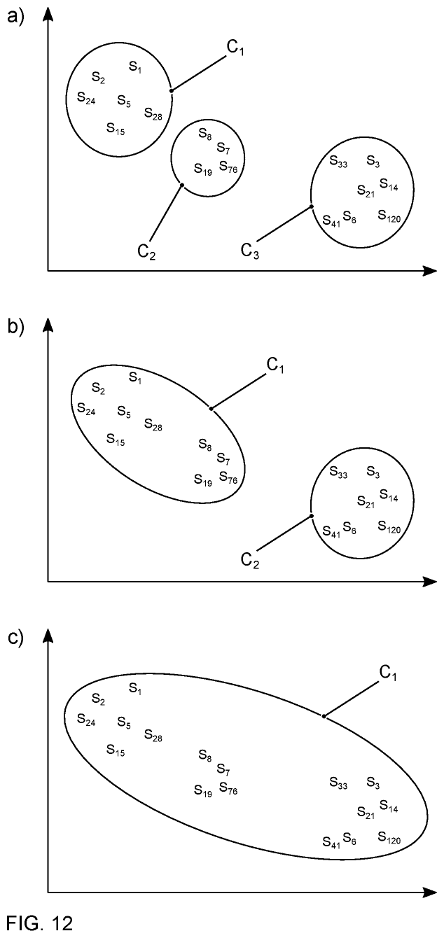

Hereafter, a vehicle is considered, which follows a route having different available bandwidths and is to continuously provide data. The route includes sections having a high bandwidth, for example due to availability of 5G in the urban areas, sections having a medium bandwidth, for example 4G in suburban areas, and sections having a low bandwidth, for example 2G in smaller towns or on rural roads. Corresponding to the available bandwidth, the clustering algorithm employed is parameterized so that a large number of clusters is formed in sections having a high bandwidth, and thus a large number of representatives is transmitted, a medium number of clusters is formed in section having a medium bandwidth, and thus a smaller number of representatives is transmitted, and few clusters are formed in sections having a low bandwidth, and thus few representatives are transmitted. The data volume to be transmitted can thus solely be adapted to the available bandwidth by clustering. FIG. 12 illustrates one example of a clustering step using a large number of clusters (FIG. 12a)), a medium number of clusters (FIG. 12b)), and few clusters (FIG. 12c)).

Hereafter, it shall be described, by way of example, how the settings of the hyperparameters can be defined for the different available bandwidths. The clustering algorithm has setting options, the so-called hyperparameters, which influence the result. Different numbers of clusters and qualities of the clustering result from the settings of the hyperparameters. The quality of the clustering is described by the so-called silhouette index.

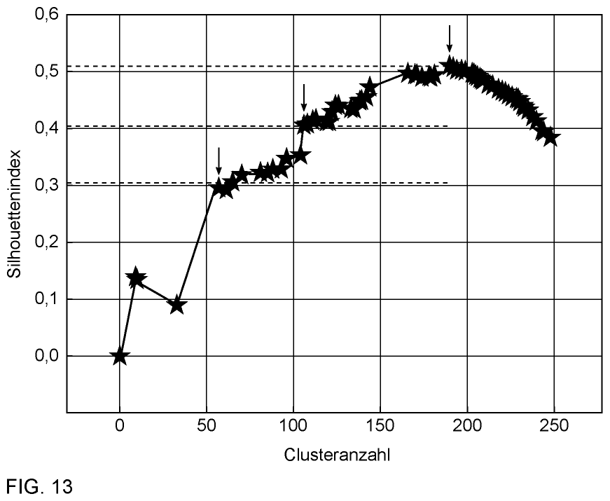

FIG. 13 shows an associated silhouette index for different numbers of clusters resulting from the clustering. Each star denotes a configuration of the clustering algorithm, and thus corresponding settings of the hyperparameters. The number of clusters resulting from the setting parameters is plotted on the x-axis, and the associated quality of the clustering algorithm, when the corresponding setting parameters are defined, is plotted on the y-axis. The data in this example stem from a vehicle, which provides approximately 400 different signals. The best result is achieved with approximately 190 clusters. The associated silhouette index is approximately 0.5. It is now possible, for example, to define three categories and to assign these to the different bandwidths. The categories are indicated by dotted horizontal lines in FIG. 13.

The first category includes configurations having a silhouette index between approximately 0.4 and the maximum. The second category includes configurations having a silhouette index between approximately 0.3 and 0.4. The third category includes configurations having a silhouette index of less than approximately 0.3. Within each category, the best available configuration is now selected during clustering. A high bandwidth results in approximately 190 clusters and a silhouette index of approximately 0.5. At a medium bandwidth, the best configuration yields approximately 102 clusters and a silhouette index of approximately 0.4. Compared to the 190 clusters, this corresponds to a reduction of the data transmission of approximately 46%. For a lower bandwidth, the best configuration yields approximately 54 clusters and a silhouette index of approximately 0.3. Compared to the 190 clusters, this corresponds to a reduction of the data transmission of approximately 70%. The respective configurations are marked by the arrows shown.

List of Reference Numerals

| | |
|---|---|
| 10 | sequencing the signals |
| 11 | determining statistical features |
| 12 | transforming a feature space |
| 13 | clustering the signals |
| 14 | determining signals as representatives for the clusters |
| 15 | providing the representatives for a transmission. |
| 20 | device |
| 21 | input |
| 22 | sequencing module |
| 23 | analysis module |
| 24 | clustering module |
| 25 | control module |
| 26 | memory |
| 27 | output |
| 28 | user interface |
| 30 | device |
| 31 | memory |
| 32 | processor |
| 33 | input |
| 34 | output |
| 40 | means of transportation |
| 41ᵢ | sensor |
| 42 | navigation system |
| 43 | data transmission unit |
| 44 | assistance system |
| 45 | memory |
| 46 | network |
| A | number of determined statistical features |
| Aᵢ_{_{—}}ₙ | segment |
| Cᵢ | cluster |
| HK | principal component |
| L | length of segments |
| m | number of segments |
| n | number of signals |
| Rᵢ | representative |
| Sᵢ | signal |
| Tᵢ | time period |

1-9. (canceled)

10. A method for processing signals in a process of continuous data provision, comprising:
sequencing the signals into segments;
determining at least one statistical feature for each of the segments;
clustering the signals based on the determined statistical features using a clustering algorithm;
determining representatives for the clusters; and
providing the representatives for transmission,
wherein the number of the clusters is automatically adapted to a changing available bandwidth by:
forming a first predetermined number of clusters when a high bandwidth is available, thus transmitting a first predetermined number of representatives;
forming a second predetermined number of clusters, less than the first predetermined number, when a medium bandwidth is available, thus transmitting a second predetermined number of representatives; and
forming a third predetermined number of clusters, less than the second predetermined number, when a low bandwidth is available, thus transmitting a third predetermined number of representatives.

11. The method of claim 10, wherein the first predetermined number of clusters, the second predetermined number of clusters, and the third predetermined number of clusters are quantitatively defined based on the bandwidth thresholds.

12. The method of claim 10, further comprising transforming a feature space of the determined statistical features into a space having a lower dimension prior to the clustering.

13. The method of claim 12, wherein the transformation of the feature space includes applying principal component analysis to the determined statistical features or selecting at least one determined statistical feature.

14. The method of claim 10, wherein the at least one statistical feature is selected from the group consisting of a mean value, a maximum value, a minimum value, and a quantile.

15. The method of claim 10, wherein the clustering employs a method selected from the group consisting of a density-based clustering method, a partitional clustering method, and a hierarchical clustering method.

16. The method of claim 10, wherein the automatic adapting of the number of clusters includes adjusting the clustering algorithm settings in real-time based on continuous monitoring of the bandwidth.

17. An apparatus for processing signals, comprising:
a sequencing module configured to sequence the signals into segments;
an analysis module configured to determine at least one statistical feature for each of the segments;
a clustering module configured to cluster the signals based on the determined statistical features using a clustering algorithm;
a selection module configured to determine representatives for the clusters; and
an output module configured to provide the representatives for transmission,
wherein the clustering module is further configured to automatically adapt the number of clusters based on changing available bandwidth by:
forming a first predetermined number of clusters when a high bandwidth is available, thus transmitting a first predetermined number of representatives;
forming a second predetermined number of clusters, less than the first predetermined number, when a medium bandwidth is available, thus transmitting a second predetermined number of representatives; and
forming a third predetermined number of clusters, less than the second predetermined number, when a low bandwidth is available, thus transmitting a third predetermined number of representatives.

18. The apparatus of claim 17, wherein the first predetermined number of clusters, the second predetermined number of clusters, and the third predetermined number of clusters are quantitatively defined based on bandwidth thresholds.

19. The apparatus of claim 17, further comprising a transformation module configured to transform a feature space of the determined statistical features into a space having a lower dimension prior to the clustering by the clustering module.

20. The apparatus of claim 19, wherein the transformation module is configured to apply principal component analysis to the determined statistical features or to select at least one determined statistical feature.

21. The apparatus of claim 17, wherein the analysis module is configured to select the at least one statistical feature from the group consisting of a mean value, a maximum value, a minimum value, and a quantile.

22. The apparatus of claim 17, wherein the clustering module is configured to employ a clustering method selected from the group consisting of a density-based clustering method, a partitional clustering method, and a hierarchical clustering method.

23. The apparatus of claim 17, wherein the clustering module is further configured to adjust clustering algorithm settings in real-time based on continuous monitoring of the bandwidth to automatically adapt the number of clusters.

24. A non-transitory computer-readable medium having computer-executable instructions stored thereon that, when executed by a processor, perform a method for processing signals in a process of continuous data provision, the method comprising:
sequencing the signals into segments;
determining at least one statistical feature for each of the segments;
clustering the signals based on the determined statistical features using a clustering algorithm;
determining representatives for the clusters; and
providing the representatives for transmission,
wherein the number of the clusters is automatically adapted to a changing available bandwidth by:
forming a first predetermined number of clusters when a high bandwidth is available, thus transmitting a first predetermined number of representatives;
forming a second predetermined number of clusters, less than the first predetermined number, when a medium bandwidth is available, thus transmitting a second predetermined number of representatives; and
forming a third predetermined number of clusters, less than the second predetermined number, when a low bandwidth is available, thus transmitting a third predetermined number of representatives.

25. The computer-readable medium of claim 24, wherein the first predetermined number of clusters, the second predetermined number of clusters, and the third predetermined number of clusters are quantitatively defined based on the bandwidth thresholds.

26. The computer-readable medium of claim 24, wherein the method further comprises transforming a feature space of the determined statistical features into a space having a lower dimension prior to the clustering.

27. The computer-readable medium of claim 26, wherein the transformation of the feature space includes applying principal component analysis to the determined statistical features or selecting at least one determined statistical feature.

28. The computer-readable medium of claim 24, wherein the at least one statistical feature is selected from the group consisting of a mean value, a maximum value, a minimum value, and a quantile.

29. The computer-readable medium of claim 24, wherein the clustering employs a method selected from the group consisting of a density-based clustering method, a partitional clustering method, and a hierarchical clustering method.
